(19) United States
(12) Patent Application Publication
(10) Pub. No.: US 2006/0152589 A1
(43) Pub. Date: Jul. 13, 2006

(54) Imaging and measurement system

(76) Inventors: Steven Morrison, East Lothian (GB); Stuart James Clarke, East Lothian (GB); Laurence Michael Linnett, East Lothian (GB)

Correspondence Address: FLESHNER & KIM, LLP, P.O. BOX 221200, CHANTILLY, VA, 20153, US

(21) Appl. No.: 10/528,990

(22) PCT Filed: Sep. 25, 2003
(86) PCT No.: PCT/GB03/04163

§ 371 Date: Feb. 24, 2006

(30) Foreign Application Priority Data
Sep. 25, 2002 (GB) 0222211.5

(51) Int. Cl. H04N 5/228; G06K 9/20; G06K 9/36

(52) U.S. Cl. 348/208.1; 382/312; 382/276

(57) ABSTRACT

Apparatus and method for presenting a highly spatially accurate visualisation of a scene from which measurements can be taken. A sensor is located in relation to a camera, and provides positional characteristics of the camera as it collects frames of video images. Using the positional characteristics the frames are corrected. The corrected frames are then synchronised to form an accurate mosaic of a scene. Example embodiments are described where the moving camera is used to survey or inspect underwater apparatus, roads, runways, railways, crime or accident scenes, archaeological digs and the inside of boilers, chimneys and pipelines.

The present invention relates to video mosaicing and, in particular, to a method and system for providing a highly spatially accurate visualisation of a scene from which measurements can be taken.

A video mosaic is a composite image produced by stitching together frames from a video sequence such that similar regions overlap. The output gives a representation of the scene as a whole, rather than a sequential view of parts of that scene, as in the case of a video survey of an area. One of the best known applications of this technique being the creation of panoramic photographs of a scene.

In publishing and image retouching applications the mosaics are manually generated which is a costly and time consuming process. More recently a system for automatically generating a mosaic has been suggested, U.S. Pat. No. 5,649,032, which provides the possibility for real-time video mosaicing. This patent details applications for display of an image, compression of an image for storage and when constructed, to a surveillance system suitable for determining enemy movement on a battlefield, a burglar entering a warehouse, and the like.

Video mosaics constructed in this fashion are not suited to applications involving the making of accurate measurements for the following reasons.

Firstly, it is vital to perform a camera calibration procedure to estimate and hence correct for the distortions caused by the internal geometry of the camera. Uncorrected, these distortions will significantly degrade the accuracy of any measurements made from the mosaic.

Secondly, the nature of the accumulation of errors in the estimation of rotations between frames leads a drift characteristic of a “random walk” which will seriously degrade the accuracy of long range measurements.

Finally, non-translational changes in the camera position (e.g. pitch and roll) will lead to perspective changes between frames which will also degrade the positional accuracy of the constructed mosaic. Although it is possible to estimate the variation in camera attitude from the video frames, the accumulation of the associated errors would again lead to degradation in measurement accuracy.

It is an object of the present invention to provide a measurement system and method using video mosaicing which obviates or mitigates at least some of the disadvantages in the prior art.

It is further object of at least one embodiment of the present invention to provide a measurement system and method to provide a highly spatially accurate visualisation of a scene from which measurements can be taken.

It is a still further object of at least one embodiment of the present invention to provide a measurement system and method from which one can make measurements of a scene to millimetre resolution.

According to a first aspect of the present invention there is provided apparatus for presenting a highly spatially accurate visualisation of a scene from which measurements can be taken, the apparatus comprising:
at least one camera for recording a plurality of frames of video images of the scene;
at least one sensor mounted in relation to the camera for recording sensor data on positional characteristics of the camera as the at least one camera is moved with respect to the scene; and
image processing means including a first module for synchronising the frames with the sensor data to form corrected frames; and a second module for constructing an accurate mosaic from the corrected frames.

By first correcting the video frames prior to the mosaiced image being formed, distortions present in the frames recorded by the one or more cameras can be removed and so enhance the spatial resolution over the entire mosaiced image.

Preferably the at least one camera is a video camera capturing 2 dimensional digital images.

The at least one sensor may comprise any sensor capable of making a positional measurement. Preferably the at least one sensor comprise sensors making a measurement relating to attitude or distance. Preferably also the at least one sensor comprises a digital compass.

Advantageously the digital compass records roll, pitch and yaw. Preferably also, the at least one sensor comprises an altimeter and/or bathymetric sensor.

Advantageously the camera(s) and sensor(s) are mounted on a moving platform. In use the platform may be mounted on a vehicle to allow movement of the camera(s) and sensor(s) over or through the scene to be imaged.

The apparatus may further include a calibration system from which the at least one camera is calibrated. In this way spherical lens distortion e.g. pincushion distortion and barrel distortion can be corrected prior to use of the camera(s). Further non-equal scaling of the pixels in the x and y axis is corrected together with a skew of the two image axis from the perpendicular.

Advantageously the calibration system includes a chessboard pattern or regular grid. This provides for multiple images to be taken from multiple viewpoints so that the distortions can be estimated and compensated for.

Preferably the first module performs a perspective correction to the images using the sensor data. Preferably also, the corrected frames are of a preselected position with reference to the scene. Optionally the corrected frames may be of preselected attitude and distance.

Preferably the second module accomplishes video mosaicing via a correlation technique based on frequency contents of the images being compared.

Preferably the apparatus further includes display means for providing a visual image of the mosaic. Preferably also the apparatus further comprises data storage means to allow the mosaic to be stored for viewing at a later time.

Preferably also the apparatus includes a graphic user interface (GUI). More preferably the GUI is included with the display system. Advantageously the GUI includes means to allow a user to select and make measurements between points in the visual image of the mosaic. Optionally the GUI provides a user with means to control the movement of the at least one camera.

According to a second aspect of the present invention there is provided a method for presenting a highly spatially accurate visualisation of a scene from which measurements can be taken, the method comprising the steps;
(a) recording a plurality of frames of video images of the scene from a camera;
(b) recording sensor data on positional characteristics of the camera as the camera is moved with respect to the scene;
(c) synchronising the frames with the sensor data to form corrected frames; and
(d) constructing an accurate mosaic from the corrected frames.

Preferably the method includes the step of calibrating the camera prior to step (a). This calibration may remove distortion effects within the camera.

Preferably the step of calibrating includes the step of taking multiple images of a chessboard pattern or regular grid from multiple viewpoints and further estimating and compensating for the distortions.

Preferably the synchronisation step includes the step of performing a perspective correction to the images using the sensor data.

Preferably also the step of video mosaicing is achieved using a correlation technique based on frequency contents of the images being compared.

Preferably the method further includes the step of providing a visual image of the mosaic.

Advantageously the method further includes the step of taking a measurement from the visual image.

Optionally the method may include the step of storing the images so that they may be accessed by spatial position.

This method may advantageously be used to record crime scenes, accident scenes, archaeological digs and the like where traditional methods of image recordal and distance measurement are time consuming. Additionally by storing the mosaiced images, distances previously not measured within the scene can be regenerated and accurately measured without having to reconstruct or preserve the original scene.

According to a third aspect of the present invention there is provided a method of performing a survey in a fluid, the method comprising the steps of;
(a) mounting a camera and a plurality of sensors on a platform capable of movement in the fluid;
(b) moving the platform through the fluid while recording visual images on the camera and taking sensor data relating to the attitude and distance of the platform from objects of interest within the fluid;
(c) synchronising the visual images to the sensor data to provide corrected visual images relating to a fixed distance and attitude;
(d) video mosaicing the images to form an accurate video mosaic as a visual image of the scene surveyed.

Preferably the method includes the step of precalibrating the camera to compensate for distorting artefacts inherent within the camera.

Preferably the method includes the step of displaying the visual image. More preferably the method includes the step of taking a measurement from the visual image.

Preferably the fluid is water, so that measurements can be made underwater. In this way pipe spool dimensions can be taken underwater as can determination be made of the degree of damage or degradation of pipelines.

Advantageously the platform may be mounted on an autonomous underwater vehicle (AUV) or a remotely operated vehicle (ROV). Alternatively the platform may be mounted on a PIG (pipeline inspection gauge), so that the camera can be moved through a pipeline to inspect the inner surface of the pipeline.

Preferably the method includes the step of storing the mosaiced images for viewing later.

Embodiments of the present invention will now be described, by way of example only, with reference to the following Figures, of which:

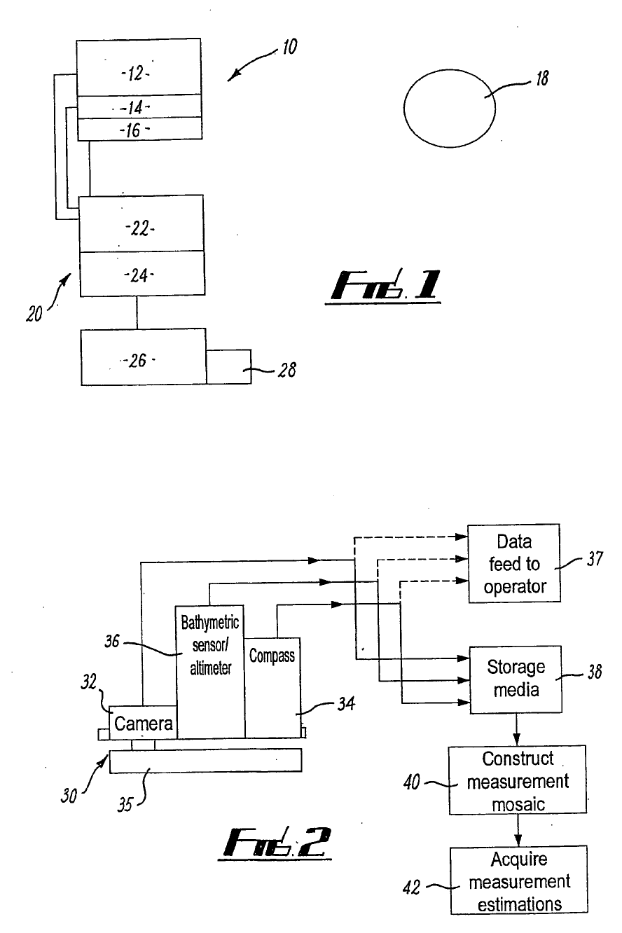

FIG. 1 is a schematic diagram of a first embodiment of the present invention;

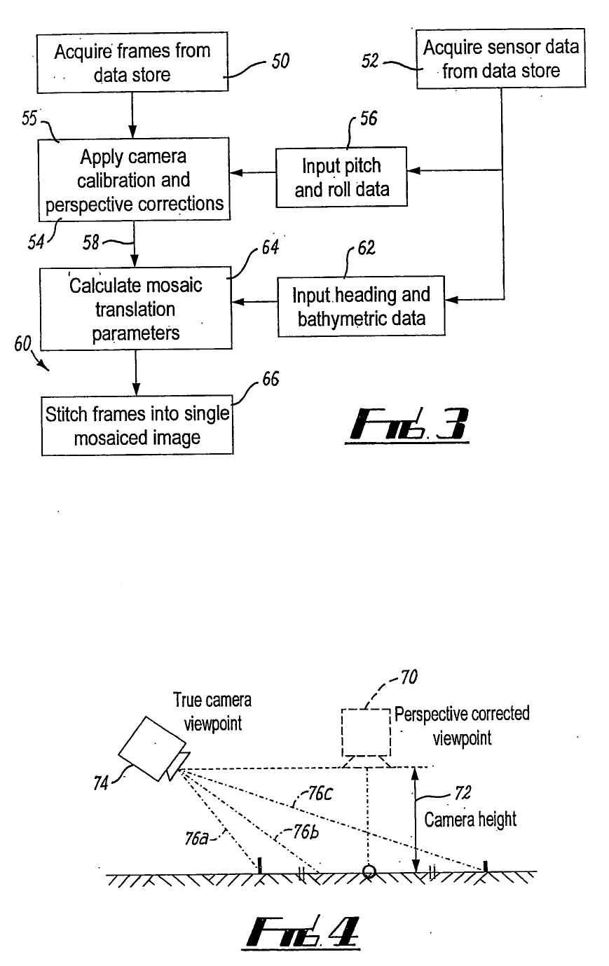

FIG. 2 is a schematic diagram of a second embodiment of the present invention;

FIG. 3 is a flow diagram depicting the stages of the sensor data integration with the algorithms required for the construction of the measurement mosaic of the second embodiment;

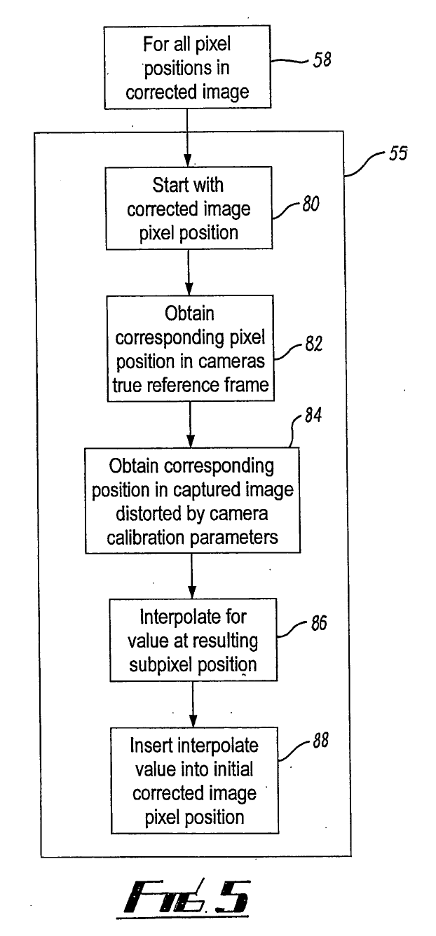

FIG. 4 depicts a schematic of the camera pose alteration required to correct for perspective in each of the image frames by application of the pitch and roll sensor data in the second embodiment;

FIG. 5 shows a flow diagram of the method applied when correcting images for the sensor roll and pitch data concurrently with the camera calibration correction as in the second embodiment;

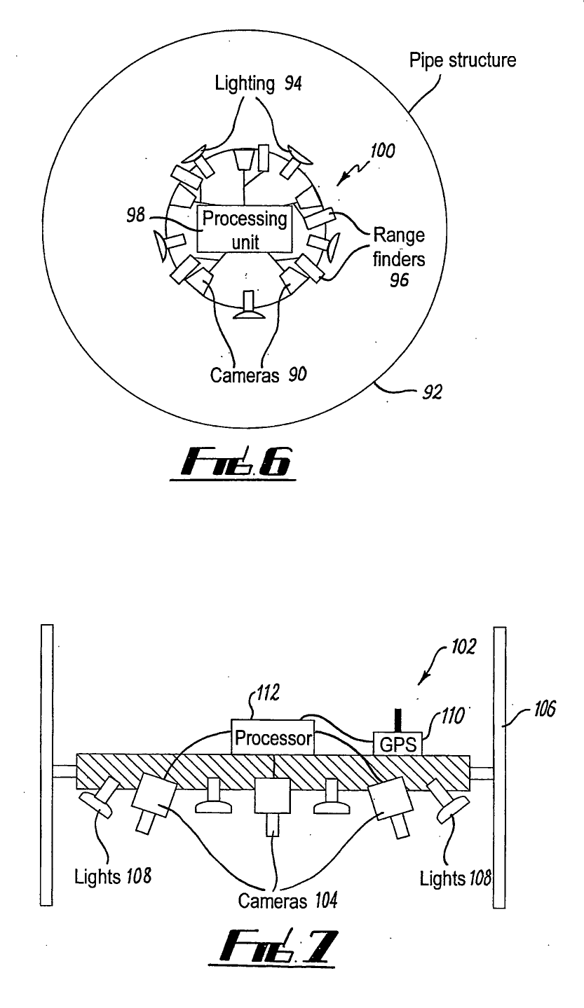

FIG. 6 is a schematic diagram of a third embodiment of the present invention; and

FIG. 7 is a schematic diagram of a fourth embodiment of the present invention.

Referring initially to FIG. 1 there is shown imaging apparatus, generally indicated by reference numeral 10, according to a first embodiment of the present invention. Apparatus 10 comprises a camera 12 mounted with sensors 14,16. The camera 12 captures a series of frames of video images as the camera 12 and sensors 14,16 are moved over an object 18. During this movement the sensors 14,16 record data on the attitude and distance of the camera 12 from the object 18. The sensor data and video images are input an image processor, generally indicated at 20. The processor 20 includes a first module 22 in which the frames are synchronised with the sensor data, as will be described hereinafter. The first module 22 outputs corrected video image from which is constructed a video mosaic in the second module 24, as described hereinafter. The video mosaic of the object 18 is displayed on a monitor 26 of a personal computer. Using a graphical user interface 28 of the personal computer a user can select points on the video mosaic and obtain distance measurements of the object 18. The measurements provide millimetre accuracy over 20 metre distances to the object. This is achieved by correcting variations in pixel dimensions with the sensor data and/or camera calibration, described hereinafter, and using the sensor data to also provide a determination of pixel dimensions in terms of real metric units.

FIG. 2 depicts a schematic diagram of a second embodiment of the present invention illustrating the hardware and the high level processes. This embodiment consists of an instrumented camera platform, generally indicated by reference numeral 30, incorporating a video camera 32 which may be analogue or digital, a digital compass 34 and an altimeter sensor 36. The sensors 34,36 measure the attitude (roll, pitch and yaw/heading) of the platform 30 and the distance from the camera platform 30 to an object being viewed. In underwater applications, an additional bathymetric sensor may be used to measure the depth of submergence of the camera platform 30. Thus the platform 30 will be mounted on a suitable vehicle 35 e.g. underwater remotely operated vehicle (ROV), aircraft or even a hand-held mounting and moved across the scene of interest. As in the first embodiment, the video and sensor data is made available to the operator 37 of the system for live display. Additionally, the video and sensor data is stored 38 in a format which allows precise synchronization between the video and sensor data. The stored data 38 may be retrieved and used to construct a video mosaic image 40 representing a plan view of the scene being surveyed where pixel scale is maintained throughout the image. During the construction of this mosaic image corrections are applied to the video frames to correct the inherent distortions due to the video camera and to compensate for the effects of camera platform attitude and distance to the viewed scene. These corrections ensure that the constructed mosaic image 40 is an accurate representation of the scene being surveyed, with the relative scales and positions of the objects contained within the scene being preserved as well as possible. Once constructed, it is possible to obtain measurements 42 of objects contained within the mosaic image using a graphical user interface.

FIG. 3 depicts a flow diagram of the stages required to construct the video mosaic image. The first stage in this process is to acquire a frame of video data 50 and the corresponding sensor data 52 for this frame, from the storage unit 38. The video frame 50 is then corrected to compensate for the effects of the camera distortion and the camera platform attitude 54. This stage requires knowledge of the camera internal parameters which are estimated by a calibration method described later, and the pitch and roll angles 56 recorded by the digital compass 34. The corrected image 58 is then input into the mosaicing procedure 60 where it is compared with the previous corrected video frame 50 in the video sequence. This procedure attempts to estimate the translation in x and y axes between the two frames by comparing the correlations between the frames in the frequency domain. The rotation between frames and the scale change between frames is determined from the compass heading and altitude/depth information 62. The next stage 64 is to apply the transformation parameters to the new frame and incorporate it into the final mosaic image 66, a process known as “stitching”. Finally the pixel size may be determined by the use of a calibration target placed in the scene, or directly from the camera calibration parameters and altimeter sensor data.

We shall consider the steps taken in the method in more detail. Beginning with the camera 32, all cameras suffer from various forms of distortion. This distortion arises from certain artefacts inherent to the internal camera geometric and optical characteristics (otherwise known as the intrinsic parameters). These artefacts include:
(a) spherical lens distortion about the principal point of the system. The two common definitions for this type of distortion are pincushion distortion and barrel distortion;
(b) non-equal scaling of pixels in the x and y-axis. This is arrived at through the estimation of the effective camera focal length in both the x and y pixel scales; and
(c) a skew of the two image axes from the perpendicular.

For high accuracy mosaicing the parameters leading to these distortions must be estimated and compensated for. In order to correctly estimate these parameters images taken from multiple viewpoints of a regular grid, or chessboard type pattern are used. The corner positions are located in each image using a corner detection algorithm. The resulting points are then used as input to a camera calibration algorithm as well documented in the literature.

The estimated intrinsic parameter matrix A is of the form

$$A = [ \begin{matrix}α & γ & {u}_{0} \\ 0 & β & {v}_{0} \\ 0 & 0 & 1\end{matrix} ]$$

where α and β are the focal lengths in x and y pixels respectively, γ is a factor accounting for skew due to non-rectangular pixels, and (u₀,v₀) is the principle point (that is the perpendicular projection of the camera focal point onto the image plane).

During the creation of the mosaic, the integration of the sensor data is performed in two phases; as is illustrated in FIG. 4. The first of these involves the use of the pitch and roll measurements 56 from the compass 34 to perform a perspective correction on each of the frames prior the mosaicing procedure 60. A diagram showing the situation modelled by this correction is provided in FIG. 4. When correcting for perspective the new camera position 70 is at the same height 72 as the original viewpoint 74, not the slant range distance 76a,b,c. Thus any correction for perturbations in pitch or roll will not be misinterpreted as a change in camera height, which may be considered either as a separate process handled within the mosaicing procedure 60 itself, or gained from the bathymetric sensor readings.

This perspective correction 54 is performed concurrently with the camera calibration correction 55 following the steps outlined in FIG. 5. FIG. 5 illustrates the steps applied to all pixel positions in the corrected image 58. Starting with the corrected image pixel position 58, we obtain the corresponding pixel position in the cameras true reference frame 82, we then obtain the position in captured image distorted by the camera calibration parameters 84, interpolate for value at resulting subpixel level 86 and insert interpolate value into initial corrected image pixel position 88.

Concatenating these two operations in this way saves on both processing time and memory requirements. These processes combine mathematically in the following way:

If u is the corrected pixel position, the corresponding position in the reference frame of the camera, normalised according the camera focal length in y pixels (β) and centred on the principle point (u₀,v₀) is c′=[(c₁″,c₂″,c₃″)/c₄″−(u₀,v₀)]/β where c″=PR_{y}RₓP⁻¹u. The pitch and roll are represented by the rotation matrices Rₓ and R_{y} respectively, with P being the perspective projection matrix which maps real world coordinates onto image coordinates. Following this the pixel position in the captured image is calculated as c=Aτ_{c′}c′. The scalar τ_{c′} represents the radial distortion applied at the camera reference frame coordinate c′. The matrix A is as defined previously.

In estimating interframe mosaicing parameters of video sequences there are currently two types of method available. The first uses feature matching within the image to locate objects and then to align the two frames based on the positions of common objects. The second method is frequency based, and uses the properties of the Fourier transform.

Given the volume of data involved (a typical capture rate being 25 frames per second) it is important that we utilise a technique which will provide a fast data throughput, whilst also being highly accurate in a multitude of working environments. In order to achieve these goals, the preferred embodiment employs the correlation technique based on the frequency content of the images being compared. This approach has two main advantages; firstly, regions which would appear relatively featureless, that is those not containing strong corners, linear features, and such like, still contain a wealth of frequency information representative of the scene. This is extremely important when mosaicing regions of the seabed for example, as definite features (such as corners or edges) may be sparsely distributed; if indeed they exist at all; and secondly, the fact that this technique is based on the Fourier transform means that it opens itself immediately to fast implementation through highly optimized software and hardware solutions.

The second phase of integration is applied in tandem with the frequency correlation technique and incorporates both the altimeter and heading readings.

The mosaicing technique is capable of estimating the rotations between adjacent frames in the mosaic to an extremely high degree of accuracy. Unfortunately, the nature of the accumulation of the errors corresponds to a stochastic process called a “random walk”. This has the effect of leading to a drift in the estimated track. For short range mosaics this effect is limited and may be discounted, thus allowing use of Fourier rotation measurements. However, for long range mosaics this will not be the case. In order to overcome this, the yaw data is utilised from the digital compass to provide a stable reference for the camera heading. This greatly increases the overall accuracy of the reconstructed mosaic.

For each image comparison, the interframe rotation and scaling values are obtained from the difference in the heading and bathymetric readings for that image pair. The second image is then corrected to the same orientation and scale of the first. This way only the translation in x and y pixels need be estimated. Having obtained the necessary parameters of the differences in position of the two images, they can be placed in their correct relative positions. The next frame is then analysed in a similar manner and added to the evolving mosaic image.

We shall now give a description of the implementation procedures used in this invention for translation estimation in Fourier space.

In Fourier space, translation is a phase shift. We therefore must utilise the differences in the phase to determine the translational shift. Let the two images be described by f₁(x,y) and f₂(x,y) where (x,y) represents a pixel at this position. Then for a translation (dx,dy) the two frames are related by
f₂(x,y)=f₁(x+dx,y+dy)

The Fourier transform magnitudes of these two images are the same since the translation only affects the phases. Let our original images be of size (cols,rows), then each of these axes represents a range of 2π radians. So a shift of dx pixels corresponds to 2π.dx/cols shift in phase for the column axis. Similarly, a shift of dy pixels corresponds to 2π.dy/rows shift in phase for the row axis.

To determine a translation, we Fourier transform the original images, compute the magnitude (M) and phases (φ) of each of the pixels and subtract the phases of each pixel to get dφ. We then take the average of the magnitudes (they should be the same) and the phase differences and compute a new set of real ( [symbol] ) and imaginary (ℑ) values as [symbol] =M cos(dφ and ℑ=M sin(dφ). These ( [symbol] ,ℑ) values are then inverse Fourier transformed to produce an image. Ideally, this image will have a single bright pixel at a position (x,y), which represents the translation between the original two images, whereupon a subpixel translation estimation may be made.

It is not always that case that the peak is unique however. When we have translation close to zero, the gained true peak is often distorted by a secondary peak at the origin. For this reason we place a lower acceptance bound on the translation. If the gained translation is lower that this, then the current new frame is discarded, and the next is compared to the same initial frame. This process has the added speed advantage that frames are only stitched into the mosaic if a reasonable translation has occurred.

A final point to note concerning this technique is that we must first window the intensity values to be Fourier transformed, ensuring that they are reduced to zero at the boundary. This removes the step discontinuities at the boundaries, making the periodic image, implied when stepping into the Fourier domain, appear continuous in all directions.

Following acquisition of the interframe mosaicing parameters it remains for the video images to be stitched into a single mosaic so that measurements between imaged positions may be achieved. This is performed using a similar philosophy to that adopted when correcting for perspective and camera calibration. Given a pixel position within the mosaic, what was the corresponding sub-pixel position in the original frame? The construction of the mosaic is also performed in such a way as to minimise the amount of memory required to contain the result.

In order to determine this mapping we first generate the camera track file containing the frame centre positions, orientations, and scale factors from the parameter file output by the mosaicing algorithm. This is done through accumulation of local translations, rotations, and scaling factors, each having undergone a rotation and scaling to make them local to the mosaic reference frame.

Following this, we may calculate the coordinates of the i^{th} frame pixel position (x_{f}_{ᵢ},y_{f}_{ᵢ}), in terms of the corresponding mosaic pixel position (xₘ,yₘ), as

$$[ \begin{matrix}{x}_{{f}_{i}} \\ {y}_{{f}_{i}}\end{matrix} ] = \frac{1}{{z}_{i}} [ \begin{matrix}cos ( {θ}_{i} ) & - sin ( {θ}_{i} ) \\ sin ( {θ}_{i} ) & cos ( {θ}_{i} )\end{matrix} ] [ \begin{matrix}{x}_{m} - \frac{{ρ}_{{c}_{i}} - 1}{2} \\ {y}_{m} - \frac{{ρ}_{{r}_{i}} - 1}{2}\end{matrix} ] + [ \begin{matrix}\frac{{f}_{c} - 1}{2} \\ \frac{{f}_{r} - 1}{2}\end{matrix} ]$$

where θ, and zᵢ are the rotation and scaling values which place the i^{th} frame into the mosaic, the size of area required to fully contain the frame in the mosaic is ρ_{c}_{ᵢ}×ρᵣ_{ᵢ} pixels, and the original frame size is f_{c}×fᵣ pixels. We then interpolate the sub-pixel value at position (x_{f}_{ᵢ},y_{f}_{ᵢ}) in frame i, and place this value into mosaic pixel position (xₘ,yₘ).

Given the stitched mosaic it remains to make a measurement between selected points in the final result.

In order to accomplish this, the pixel size must be determined through use of either a calibration target placed in the scene, or through use of the camera calibration parameters and altimeter sensor data. Following this calibration, the distance in pixels between the selected points is multiplied by the true distance subtended by each pixel to provide an accurate length measurement.

The apparatus and method of the present invention lends itself to the following applications particularly as applied to underwater surveying:
(a) Metrology, through the measurement of physical dimensions in difficult to access environments;
(b) Geo-referencing—in conventional video surveys the data is stored in a video format where each part of the survey is accessed by frame number. Under the present invention a survey can be stored as one or more mosaiced images which can advantageously be accessed by spatial position and integrated with other geo-referenced data such as maps, sidescan sonar, and engineering drawings;
(c) Video compression—while video recording of a survey requires vast storage capacity and leads to data being stored on difficult to access magnetic tape media or in compressed forms on a computer, the present invention provides a compact data size as redundant information when images overlap is removed. This is done with very little degradation to the image quality compared to video compression, methods. It is also possible to reconstruct a video of the original video survey; and
(d) Navigation as the video mosaicing process involves the measurement of translations rotations and scalings that are present in the video sequence, the apparatus can provide navigational information about the platform on which it may be mounted. As the navigational information extracted from the video sequence may be extremely accurate (<1 cm) over short ranges, the information can be used to aid positioning of equipment, station holding and offers a potential benefit to the development of a synthetic aperture sonar system.

It will be appreciated that the second embodiment could be adapted to inspect ships' hulls in order to check for hull integrity or the prevention of smuggling or terrorist threats. In this application the camera(s) and sensors are mounted onto a remotely operated vehicle (ROV) which is used to scan the hull of the ship. In this configuration, the sensors could include an altimeter to measure distance between the camera and ship hull, and a digital compass unit to measure the platform attitude. The sensor data can be used to apply scaling and perspective corrections respectively to the camera frames, prior to mosaicing the video frames into a large image. The mosaic image may be used to identify the position of any area of interest on the ship's hull.

A further application of this methodology is that of internal pipe-like structure inspection, where pipe-like structures include pipelines, boilers, and chimneys for example. In this embodiment a system 100 includes a plurality of cameras 90 are placed in a circular arrangement as shown in FIG. 6 to provide a 360 degree field of view, and images gathered of the surrounding surface 92. Lighting sources 94 are placed adjacent to the cameras 90; suitably illuminating the surface 92 being inspected. The cameras 90 are synchronised with images gathered instantaneously being distortion corrected depending on the camera calibration parameters, arrangement of the cameras, and position of the camera system within the pipe structure, thereby providing images from which the accurate measurements of distances along the pipe sidewall 92 may be obtained. The position within the structure can be determined by separate range finding sensors 95 mounted locally to each camera and synchronised with that camera, these supply the distance to the pipe structure sidewall of that camera. Via a processor 98 the instantaneously grabbed images are then accumulated into a mosaiced image strip containing the entire imaged surface at that particular moment in time. The system 100 can be propelled through a boiler or pipe like structure via any means including gravity (a vertical pipeline or chimney for example), a pulley system pulling/pushing the setup, or by attaching to the camera rig an arrangement of support struts with wheels, these may be motorised or pushed/pulled through the pipe structure by some external means. As the number of strips accumulates over time they are automatically stitched to form a mosaic of the surface under inspection; the inside of a pipe, chimney, or boiler.

A yet further application of an embodiment of invention described here is in the inspection of roads, runways and railway lines. In this embodiment the system 102 could consist of video cameras 104 mounted on a suitable vehicle 106 facing towards the ground with the addition of suitable lighting 108 to illuminate the surface being inspected. In this configuration the additional sensors could include a GPS receiver 110 that can be used to provide additional global positioning information synchronised to the video data. The video frames will be corrected for camera and perspective distortion prior to input to the mosaicing operation in the processor 112. A video mosaic constructed from the combined (in the case of more than one camera) and corrected video frames will be generated. This image may be used to identify and measure surface defects and to determine global positions of these defects. The incorporation of GPS positional information can further enable the generated mosaic image to be referenced to a geographical information system (GIS).

The main advantage of the present invention is that it provides a video mosaic image from which measurements with millimetre accuracy can be taken. High spatial resolution is attainable by fusing the sensor data with the video images and then reconstructing the mosaic from a selected reference point. This allows measurements to be made from the video mosaic as the pixel dimensions are provided in terms of metric units scaled from the objects being surveyed. Use of a correlation technique based on the frequency content of the images being compared provides the advantages of allowing imaging of generally featureless scenes such as the seabed and as the technique is based on the Fourier Transform the data can be processed in real time through the implementation of highly optimised software and hardware solutions.

Further the present invention provides advantages over traditional ways of obtaining measurements. Firstly, it may be used in environments where it is either hazardous or difficult to use conventional manual measurement methods. For example the measurement of pipeline spool pieces on the seafloor, can be conducted by mounting the camera and sensors on an ROV which can be flown over the two ends of the pipeline to be connected by the spool piece. Currently a method involving triangulation of acoustic transceivers is employed for this application. This is a time consuming method which requires the use of divers and some expert knowledge. A second advantage is that in the case of scenes containing a number of objects that must have their positions or separations recorded, a survey can be conducted and the measurements made at a later time, with the minimum of delay incurred at the scene. This would be a considerable benefit in recording accident scenes or archaeological digs.

It will be appreciated by those skilled in the art that various modifications may be made to the invention herein described without departing from the scope thereof.

1-25. (canceled)

26. An apparatus for presenting a highly spatially accurate visualization of a scene from which measurements can be taken, the apparatus comprising:
at least one camera for recording a plurality of frames of video images of the scene;
at least one sensor mounted in relation to the camera for recording sensor data on positional characteristics of the camera as the at least one camera is moved with respect to the scene; and
image processing means including a first module for synchronizing the frames with the sensor data to form corrected frames, and a second module for constructing an accurate mosaic from the corrected frames.

27. The apparatus as claimed in claim 26, wherein the at least one camera is a video camera capturing two dimensional digital images.

28. The apparatus as claimed in claim 26, wherein the at least one sensor comprises a sensor capable of making a positional measurement.

29. The apparatus as claimed in claim 28, wherein the at least one sensor comprises a digital compass.

30. The apparatus as claimed in claim 28, wherein the at least one sensor comprises an altimeter and/or bathymetric sensor.

31. The apparatus as claimed in claim 26, wherein the at least one camera and the at least one sensor are mounted on a moving platform.

32. The apparatus as claimed in claim 26, wherein the apparatus further includes a calibration system from which the at least one camera is calibrated.

33. The apparatus as claimed in claim 26, wherein the first module performs a perspective correction to the images using the sensor data.

34. The apparatus as claimed in claim 26, wherein the second module accomplishes video mosaicing via a correlation technique based on frequency contents of the images being compared.

35. The apparatus as claimed in claim 26, wherein the apparatus further includes display means for providing a visual image of the mosaic.

36. The apparatus as claimed in claim 26, wherein the apparatus further comprises data storage means to allow the mosaic to be stored.

37. The apparatus as claimed in claim 26, wherein the apparatus includes a graphic user interface (GUI).

38. A method for presenting a highly spatially accurate visualization of a scene from which measurements can be taken, the method comprising:
(a) recording a plurality of frames of video images of the scene from a camera;
(b) recording sensor data on positional characteristics of the camera as the camera is moved with respect to the scene;
(c) synchronizing the frames with the sensor data to form corrected frames; and
(d) constructing an accurate mosaic from the corrected frames.

39. The method as claimed in claim 38, wherein the method includes a step of calibrating the camera prior to performing step (a).

40. The method as claimed in claim 38, wherein the synchronization step includes the step of performing a perspective correction to the images using the sensor data.

41. The method as claimed in claim 38, wherein the step of video mosaicing is achieved using a correlation technique based on frequency contents of the images being compared.

42. The method as claimed in claim 38, wherein the method further includes the step of providing a visual image of the mosaic.

43. The method as claimed in claim 38, wherein the method further includes the step of taking a measurement from the visual image.

44. The method as claimed in claim 38, wherein the method includes the step of storing the images so that they may be accessed by spatial position.

45. A method of performing a survey in a fluid, the method comprising:
(a) mounting a camera and a plurality of sensors on a platform capable of movement in the fluid;
(b) moving the platform through the fluid while recording visual images on the camera and recording sensor data relating to the attitude and distance of the platform from objects of interest within the fluid;
(c) synchronizing the visual images to the sensor data to provide corrected visual images relating to a fixed distance and attitude; and
(d) video mosaicing the images to form an accurate video mosaic as a visual image of the scene surveyed.

46. The method as claimed in claim 45, wherein the method includes the step of pre-calibrating the camera to compensate for distorting artifacts inherent within the camera.

47. The method as claimed in claim 45, wherein the method includes the step of displaying the visual image.

48. The method as claimed in claim 45, wherein the method includes the step of taking a measurement from the visual image.

49. The method as claimed in claim 45, wherein the platform is mounted on a remotely operated vehicle (ROV).

50. The method as claimed in claim 45, wherein the method includes the step of storing the mosaiced images for viewing later.
